(19) United States
(12) Patent Application Publication
(10) Pub. No.: US 2005/0119924 A1
(43) Pub. Date: Jun. 2, 2005

(54) Computerized methods and software for business management

(76) Inventors: Brian R. Simpson, St. Louis, MO (US); Douglas Reineri, Manchester, MO (US); Brian Woodrick, St. Louis, MO (US)

Correspondence Address: HARNESS, DICKEY, & PIERCE, P.L.C, 7700 BONHOMME, STE 400, ST. LOUIS, MO, 63105, US

(21) Appl. No.: 10/910,264

(22) Filed: Aug. 2, 2004

Related U.S. Application Data
(60) Provisional application No. 60/492,165, filed on Aug. 1, 2003.

(51) Int. Cl. G06F 17/60

(52) U.S. Cl. 705/7

(57) ABSTRACT

Computer-implemented methods and software for managing business of service providers including, without limitation, Internet-related service providers. According to one aspect, the life cycle of a customer can be managed via a single application program, and preferably via a single interface, from initial contact through service cancellation. According to another aspect, a user can be assigned to a workgroup with a specified permission that controls the user's access to one or more resources associated with the workgroup. Further, a computer display may include a first static portion for displaying static customer information and a second dynamic portion for displaying other customer information selected by a user.

### CROSS-REFERENCE TO RELATED APPLICATIONS

This application claims the benefit of U.S. Provisional Application No. 60/492,165 filed Aug. 1, 2003, the entire disclosure of which is incorporated herein by reference.

### FIELD OF THE INVENTION

The present invention relates to computerized methods and software and, more particularly, to computer software for managing business of service providers including, without limitation, Internet-related service providers.

### BACKGROUND OF THE INVENTION

A variety of software applications are known in the art for managing different aspects of a service provider's business. For example, software applications are known for managing accounting and billing, while other software applications are known for managing the provisioning of services, or trouble ticketing, or prospecting, etc.

As recognized by the inventors hereof, there are a number of disadvantages associated with existing business management software applications with respect to user interfaces, security, convenient access to varied customer information, etc.

### SUMMARY OF THE INVENTION

In order to solve these and other needs in the art, the inventors hereof have succeeded at designing and developing a number of improvements in business management software, particularly for service providers, that can be advantageously implemented individually or in combination.

According to one aspect of the present invention, a computer system includes a graphical user interface including a display and a user interface selection device. The display includes at least a first static portion and a second dynamic portion. A method of controlling customer information provided in the display includes displaying information relating to a customer in the first static portion of the display, and displaying information relating to the customer in the second dynamic portion of the display in response to user input via the user interface selection device. The information displayed in the second dynamic portion is different than the information displayed in the first static portion. The user input provided via the user interface selection device alters the information displayed in the second dynamic portion of the display without altering the information displayed in the first static portion of the display.

According to another aspect of the present invention, a computer-implemented method of controlling user access to resources provided by a computer application includes assigning a user to a workgroup having one or more of the resources associated therewith, and specifying a permission for the user with respect to the workgroup. The specified permission controls the user's access to the one or more resources associated with the workgroup.

According to still another aspect of the present invention, a computer-implemented method is provided for managing business of a service provider via a single computer application. The method includes storing information for a business contact in the single computer application and managing a life cycle of the business contact from initial contact through service cancellation via the single computer application.

Further aspects and features of the present invention will be in part apparent and in part pointed out below.

### BRIEF DESCRIPTION OF THE DRAWINGS

The present invention will become more fully understood from the detailed description and the accompanying drawings.

FIG. 1 is a flow diagram of a computerized method according to one embodiment of the present invention.

FIG. 2 is a screen display illustrating the assignment of user permissions according to the method of FIG. 1.

FIG. 3 is a flow diagram of a computerized method according to another embodiment of the present invention.

FIGS. 4-6 are screen displays depicting a display of a graphical user interface having both static and dynamic display portions.

Corresponding reference characters indicate corresponding features throughout the several views of the drawings.

### DETAILED DESCRIPTION OF EXEMPLARY EMBODIMENTS

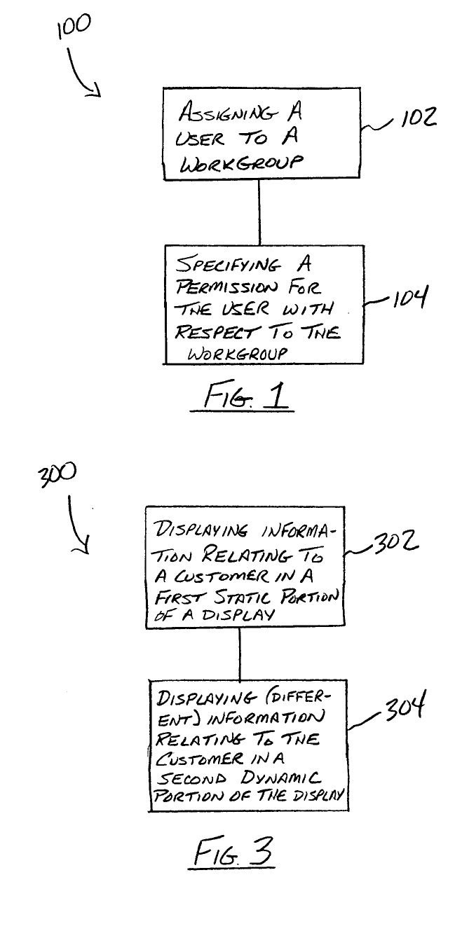

A computer-implemented method of controlling user access to resources provided by a computer application according to the principles of the present invention is illustrated in FIG. 1 and indicated generally by reference character 100. As shown in FIG. 1, the method 100 includes, at block 102, assigning a user to a workgroup. As apparent to those skilled in the art, the workgroup can have one or more resources associated therewith. The method further includes, at block 104, specifying a permission for the user with respect to the workgroup. According to the principles of the present invention, the specified permission controls the user's access to the one or more resources associated with the workgroup.

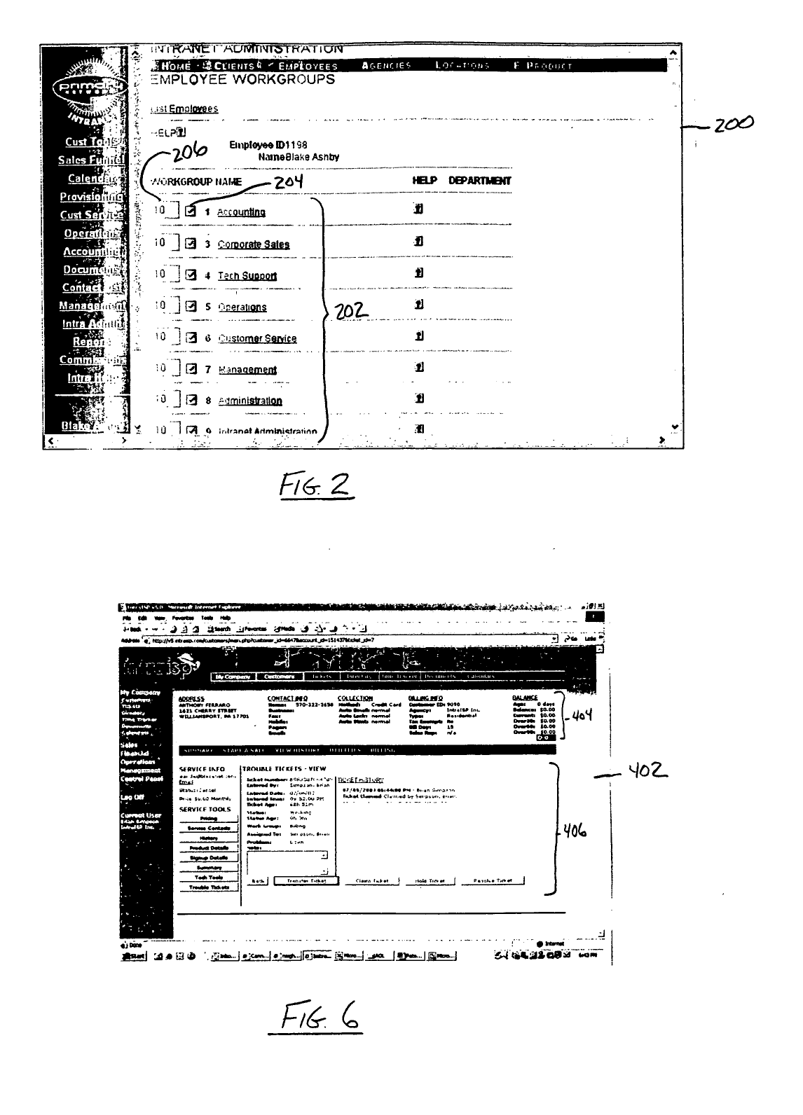

One preferred implementation of the method 100 will now be described with reference to FIG. 2, which illustrates a screen display 200 in a computer application for managing business of a service provider. In this particular example, as well as other examples discussed below, the illustrated software is specifically adapted for managing business of a wireless or wireline service provider, such as an Internet Service Provider (ISP) or the provider of wireless internet service (WIS), broadband over power line (BPL), voice over IP (VoIP), etc. It should be understood, however, that the teachings of the present invention are not so limited. Further, the illustrated software is preferably web-enabled so as to permit use of the software by remote users over the Internet.

As shown in FIG. 2, the screen display 200 depicts a number of workgroups 202, including those for accounting, corporate sales, technical support, operations, customer service, management, administration, etc. In this particular embodiment, each workgroup 202 has a checkbox 204 associated therewith. Thus, by checking (or unchecking) the checkbox 204 associated with the “accounting” workgroup, a user (e.g., Blake Ashby in the example of FIG. 2) is assigned (or unassigned) to the accounting workgroup. As should be apparent, the user may be an employee of the service provider such as a salesperson, customer service representative, accountant, manager, etc. Additionally, a permission can be specified for such user with respect to, e.g., the accounting workgroup via a permission box 206. In this particular embodiment, the permission is specified in terms of a permission level on a scale of one to ten, as shown in FIG. 2. Thus, by specifying the highest permission level of ten in the permission box 206, the user will have full access to all resources associated with the accounting workgroup. Alternatively, if the user is assigned a lower permission level, such as six, the user will have reduced assess to the resources associated with that workgroup. For example, the user's access to certain resources may be read-only, without editing privileges, and possibly with no access to certain other resources associated with the accounting workgroup 202. The relationship between an assigned permission level and its effect on the user's access to workgroup resources can be set as desired for any given application of the invention and may vary from application to application.

In the embodiment of FIG. 2, the permission specified for a user (via the permission box 206) controls the user's access (including lack of access, where applicable) to all resources associated with the workgroup in question. Alternatively, the user's permission with respect to a workgroup could instead be specified with respect to individual resources or resource groups associated with the workgroup. For example, rather than assigning a single permission level for an entire workgroup, the system could be configured so that a system administrator could selectively enable or disable, for a particular user, each of various resources or (potentially default) permissions associated with that workgroup. In the case where default permissions are employed, such default permissions can preferably be revoked or overridden, as applicable, by a system administrator.

A computer-implemented method 300 of controlling the display of customer information in accordance with the principles of the present invention is illustrated generally in FIG. 3. The method 300 can be performed in a computer system having a graphical user interface including a display and a user interface selection device, where the display includes at least a first static portion and a second dynamic portion. As shown in FIG. 3, the method 300 includes, in block 302, displaying information relating to a customer in the first static portion of the display. The method 300 further includes, in block 304, displaying information relating to the customer in the second dynamic portion of the display. The information displayed in the second dynamic portion is different than the information displayed in the first static portion. According to this aspect of the present invention, user input provided via the user interface selection device alters the information displayed in the second dynamic portion of the display without altering the information displayed in the first static portion of the display.

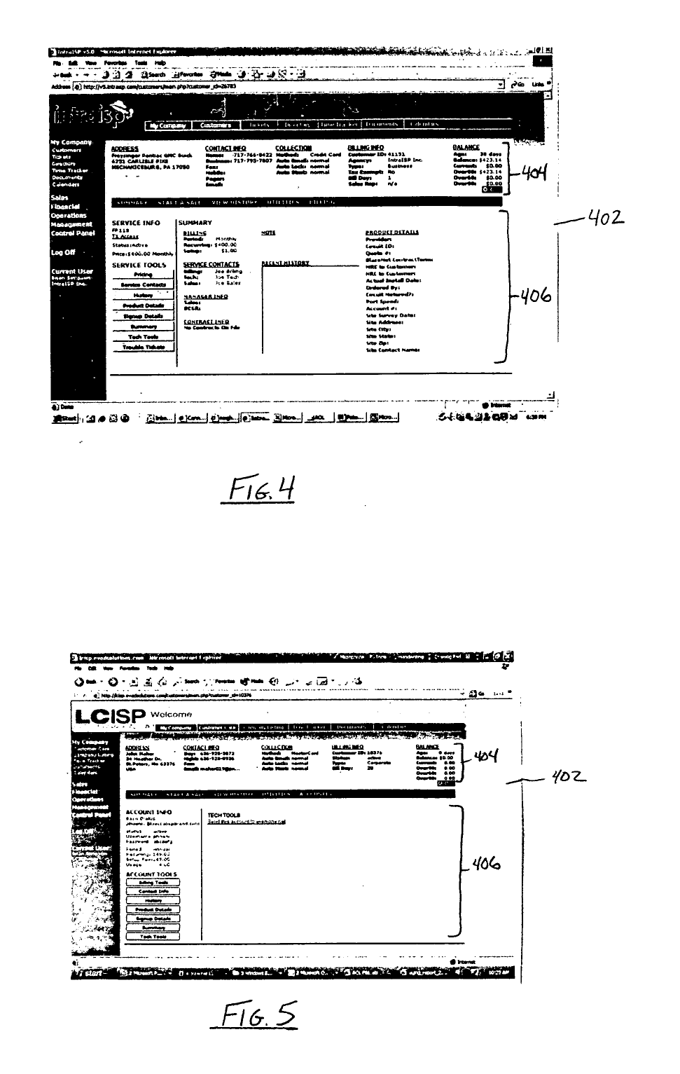

One preferred implementation of this method 300 will now be described with reference to FIGS. 4-6. As shown therein, a display 402 for a graphical user interface includes a first static portion 404 and a second dynamic portion 406. In this particular example, the first static portion 402 includes contact information (e.g., telephone numbers) as well as accounting information (e.g., collection information, billing information, and account balance information) for a customer. The same information is displayed in the static portion 402 in each of FIGS. 4-6. In contrast, different information is displayed in the dynamic portion 406 in each of FIGS. 4-6. Specifically, customer summary information is displayed in the dynamic portion 406 of FIG. 4, technical tools information is displayed in the dynamic portion 406 of FIG. 5, and trouble tickets information is displayed in the dynamic portion 406 of FIG. 6. In each of FIGS. 4-6, the information displayed in the dynamic portion 406 is a function of user input provided via the user interface selection device (e.g., a computer mouse, keyboard, touch screen, pointer, etc.), such as a user selection from a list of corresponding menu items. In this particular example, the information displayed in the second dynamic portion 406 of the display 402 may be summary, new sale, customer history, utilities, billing, or trouble ticket information.

Importantly, because the display 402 includes the static portion 404 and the dynamic portion 406, with the same information preferably displayed in the static portion 404 regardless of what information is displayed in the dynamic portion 406, the information provided in the static portion (in this example, general customer data) is always readily available to a user of the system. While the static portion is positioned directly above the dynamic portion of the display in FIGS. 4-6, other orientations can be employed without departing from the scope of the present invention.

A computerized-method of managing business of a service provider via a single computer application includes storing information for a business contact in the single computer application, and managing a life cycle of the business contact from initial contact through service cancellation via the single computer application. Thus, in contrast to using multiple computer applications for managing various aspects of a service provider's business, a single application can be provided for this purpose. Although applicable to a wide variety of service providers, this aspect of the invention is particularly useful for managing business of wireless and wireline service providers.

The life cycle for a given business contact may include multiple events, such as the initial customer meeting, service proposal, contract, provisioning (i.e., customer setup which may include, in the case of internet access service, the providing of a physical line, communication hardware, and internet access service), billing, trouble ticketing, commissioning, and cancellation (which may include de-provisioning). By providing a single application with the ability to manage some or all these events, overall customer management can be consolidated and simplified for users of the application.

In one preferred embodiment, life cycle management is accomplished through the combination of Operating Support Systems (OSS) and Customer Relations Management (CRM) all from a central portal. The system includes modules designed to manage specific aspects of the customer life cycle into 5 distinct modules familiar to service provider organizations:

(1) Sales Module—an integrated prospecting database for housing, managing and reporting on potential clients of the provider organization and/or its business units. Daily contact management, task assignment, performance tracking and commissions calculations are components of this system. Conversion from contact to prospect to customer can occur seamlessly and without need for redundant points of entry. Conversion from prospect to customer can also spawn a customizable provisioning process with multiple provider/product combinations for both residential and business customers. The system can support direct sales employees, subcontractors, sales agents, channel partners, franchisees, etc.

(2) Operations Module—Operational Support Systems (OSS) such as integrated services can include a powerful, fast, and complex RADIUS server compatible with the latest network protocols and practices, and DNS and e-mail management tools which allow users to modify, add, change and delete DNS and e-mail records in real time. Customizable provisioning process management can allow a multiplicity of diverse and complex products and services to be created and installed.

(3) Financial Module—complete accounts receivable functionality including General Ledger and Chart of Accounts interface with a unique regional allocation of revenues based on inheritable properties defined by the user. Automated collections and term of service violation processes allow service providers to manage collections on a large scale without manual intervention. Real time credit card processing and automated lock box capabilities can be provided for integration with multiple third party providers of financial services.

(4) Management Module—real time and near real time reporting capabilities can enable service providers the ability to analyze the complexities of managing the organization and its business units operating under or in tandem with them.

(5) Control Panel—system administration interfaces are available through this module. The Control Panel may contain over 60 interfaces for customizing the application at a myriad of levels from products and services to process scheduling, user management, workgroup management, business unit profiles, etc. The combination of customizable options allows the system to be uniquely customized to fit a variety of service provider business models.

While described above in terms of software and methods, it should be understood that the present invention also relates to systems employing the unique features and functions described above, as well as computer-readable media (hard drives, CD-ROMs, DVDs, and other static or dynamic memory devices) on which computer instructions are recorded for implementing the methods and features described herein.

When introducing features of the invention or embodiments thereof, the articles “a”, “an”, “the”, and “said” are intended to mean that there are one or more of such features. The terms “comprising”, “including”, and “having” are intended to be inclusive and mean that there may be additional features other than those listed.

As various changes could be made in the above exemplary embodiments and methods without departing from the scope of the invention, it is intended that all matter contained in the above description or shown in the accompanying drawings shall be interpreted as illustrative and not in a limiting sense.

1-20. (canceled)

21. A computer-implemented method of managing business of a service provider via a single computer application, the method comprising storing information for a business contact in the single computer application and managing a life cycle of said business contact from initial contact through service cancellation via the single computer application.

22. The method of claim 21 wherein said life cycle further includes one or more events selecting from the group consisting of initial meeting, proposal, contract, provisioning, billing, and commissioning.

23. The method of claim 21 wherein the service provider is a provider of a wireless or wireline service.

24. The method of claim 23 wherein said wireless or wireline service is an Internet service.

25. The method of claim 21 wherein the computer application is web enabled.

26. A computer-readable medium having computer-executable instructions for performing the method of claim 21.

27. A computer-implemented method of managing business of a wireless or wireline service provider via a single computer application, the method comprising storing information for a business contact in the single computer application and managing at least accounting and trouble ticketing for said business contact via the single computer application.

28. The method of claim 27 wherein managing further includes managing provisioning for said business contact via the single computer application.

29. The method of claim 28 wherein the computer application is web enabled and managing includes managing at least the accounting, provisioning and trouble ticketing for said business contact via a single web portal.

30. A computer-implemented method of managing business of a service provider via a single computer application, the method comprising storing information for a business contact in the single computer application and managing a life cycle of said business contact from initial contact, meeting, proposal, contract, provisioning, billing, commissioning, and cancellation via the single computer application.

31. The method of claim 30 wherein managing the life cycle of said business contact includes managing the life cycle via a single interface of the computer application.

32. A computer-readable medium having computer-executable instructions for performing the method of claim 30.
